(19) United States
(12) Patent Application Publication
(10) Pub. No.: US 2006/0181228 A1
(43) Pub. Date: Aug. 17, 2006

(54) Device for controlling drive current for an electroluminescent device array with amplitude shift modulation

(75) Inventor: Jorge Sanchez-Olea, Poway, CA (US)

Correspondence Address: HIGGS, FLETCHER & MACK LLP, 2600 FIRST NATIONAL BANK BUILDING, 401 WEST "A" STREET, SAN DIEGO, CA, 92101-7910, US

(73) Assignee: CEYX TECHNOLOGIES, Inc., San Diego, CA (US)

(21) Appl. No.: 11/400,491

(22) Filed: Apr. 7, 2006

Related U.S. Application Data
(60) Provisional application No. 60/669,467, filed on Apr. 8, 2005.
(60) Provisional application No. 60/738,557, filed on Nov. 21, 2005.
(60) Provisional application No. 60/740,039, filed on Nov. 28, 2005.

(30) Foreign Application Priority Data
Nov. 8, 2004 (WO) PCT/US04/37504
Feb. 6, 2004 (WO) PCT/US04/03400

(51) Int. Cl. H05B 39/00

(52) U.S. Cl. 315/312

(57) ABSTRACT

An electrical circuit includes a switch having an on state and an off state for connecting a single drive current power source in series with an electroluminescent device for each electroluminescent device of an electroluminescent device array to conduct a first drive current through the electroluminescent device in the on state. The switch connects an amplitude shift load in series with the electroluminescent device and the drive current power source to conduct a second drive current through the electroluminescent device in the off state. The first drive current and the second drive current constitute an amplitude shift modulated drive current through the electroluminescent device. A control signal generator receives a digital switch command for each electroluminescent device from an electroluminescent device controller and generates an amplitude shift control signal to cause the switch to switch between the on state and the off state for regulating an average of the amplitude shift modulated drive current.

### CROSS-REFERENCE TO RELATED APPLICATIONS

This application is a continuation-in-part of co-pending PCT Application No. PCT/US04/37504, having an international filing date of Nov. 8, 2004. This application also claims the benefit of U.S. Provisional Application No. 60/669,467, filed Apr. 8, 2005, U.S. Provisional Application No. 60/740,039, filed Nov. 28, 2005 and U.S. Provisional Application No. 60/738,557 filed Nov. 21, 2005. PCT Application No. PCT/US04/37504 is a continuation-in-part of co-pending PCT Application No. PCT/US04/003400, having an international filing date of Feb. 6, 2004. PCT Application No. PCT/US04/37504 also claims the benefit of U.S. Provisional Application No. 60/518,490, filed Nov. 6, 2003. PCT Application No. PCT/US04/003400 claims the benefit of U.S. Provisional Application No. 60/445,914, filed Feb. 6, 2003. Each of the above applications is incorporated entirely herein by reference.

### BACKGROUND OF THE INVENTION

1. Field of the Invention

The embodiments disclosed herein relate generally to the manufacture and architectural features of integrated circuits, and more specifically to the manufacture and architecture of Application Specific Integrated Circuits (ASIC) for power control of high voltage devices.

2. Description of Related Art

Circuits for controlling high voltage devices are typically implemented with discrete components in many high voltage industrial and consumer applications such as amplifiers, switches, motors, relays, and fluorescent lamps used to provide backlighting in Liquid Crystal Displays (LCDs). Cold Cathode Fluorescent Lamps (CCFL) are widely used for backlighting LCDs in televisions, notebook and laptop computer monitors, car navigation displays, point of sale terminals, and medical equipment.

### SUMMARY OF THE INVENTION

In one embodiment, an electrical circuit includes:

a switch having an on state and an off state for connecting a single drive current power source in series with an electroluminescent device for each electroluminescent device of an electroluminescent device array to conduct a first drive current through the electroluminescent device in the on state and for connecting an amplitude shift load in series with the electroluminescent device and the drive current power source to conduct a second drive current through the electroluminescent device in the off state so that the first drive current and the second drive current constitute an amplitude shift modulated drive current through the electroluminescent device; and

a control signal generator for receiving a digital switch command for each electroluminescent device from an electroluminescent device controller and for generating an amplitude shift control signal to cause the switch to switch between the on state and the off state for regulating an average of the amplitude shift modulated drive current.

In another embodiment, an integrated circuit includes:

a common substrate;

a switch having an on state and an off state formed on the common substrate for connecting a single drive current power source in series with an electroluminescent device for each electroluminescent device of an electroluminescent device array to conduct a first drive current through the electroluminescent device in the on state and for connecting an amplitude shift load in series with the electroluminescent device and the drive current power source to conduct a second drive current through the electroluminescent device in the off state so that the first drive current and the second drive current constitute an amplitude shift modulated drive current through the electroluminescent device; and

a control signal generator formed on the common substrate for receiving a digital switch command for each electroluminescent device from an electroluminescent device controller and for generating an amplitude shift control signal to cause the switch to switch between the on state and the off state for regulating an average of the amplitude shift modulated drive current; and at least one of:
a bypass diode formed on the common substrate and coupled to the switch;
a strike detector formed on the common substrate for generating a struck signal when the average drive current exceeds a minimum drive current threshold in every electroluminescent device in the electroluminescent device array and for holding the switch in the on state until the struck signal is generated,
a strike detector formed on the common substrate for generating a struck signal when the drive current source has been powered on for a selected time interval and for holding the switch in the on state until the struck signal is generated,
a drive current sensor formed on the common substrate for measuring one of the average, instantaneous, or root-mean-square amplitude shift modulated drive current and an average, instantaneous, or root-mean-square amplitude shift modulated load current and for generating an analog or a digital output to the electroluminescent device controller having a value that is representative of a linear function of one of the average amplitude shift modulated drive current and the average amplitude shift modulated load current;
a reference current source; and
a shift register or latch formed on the common substrate for one of assembling the amplitude shift control signal for every electroluminescent device in the electroluminescent device array into a digital word, for assembling a test signal into the digital word that includes a bit for selecting one of a current mirror to measure one of the average amplitude shift modulated drive current and an average amplitude shift modulated load current, and for selecting a test point in the electrical circuit to couple to the electroluminescent device controller.

### BRIEF DESCRIPTION OF THE DRAWINGS

The above and other aspects, features and advantages will become more apparent from the description in conjunction with the following drawings presented by way of example and not limitation, wherein like references indicate similar elements throughout the several views of the drawings, and wherein:

FIG. 1 illustrates a diagram of a backlight for a fluorescent lamp array in which an alternating drive current from a single drive current power source is separately controlled through each lamp by amplitude shift modulation performed by an integrated circuit;

FIG. 2 illustrates a schematic diagram of an embodiment of the integrated circuit in FIG. 1;

FIG. 3 illustrates a timing diagram of amplitude shift control signals having three different duty cycles and the instantaneous amplitude shift modulated drive current through the switches in FIG. 2;

FIG. 4 illustrates a diagram of a backlight for a fluorescent lamp array in which an alternating drive current from a single drive current power source is separately controlled through each fluorescent lamp by amplitude shift modulation performed by two of the integrated circuits of FIG. 2;

FIG. 5 illustrates a diagram of a backlight for a fluorescent lamp array in which an alternating drive current from two differentially configured drive current power sources is separately controlled through each lamp by amplitude shift modulation performed by two of the integrated circuits of FIG. 2; and

FIG. 6 illustrates a diagram of a backlight for a fluorescent lamp array in which an alternating drive current from four differentially configured drive current power sources is separately controlled through each fluorescent lamp by amplitude shift modulation performed by four of the integrated circuits of FIG. 2.

Elements in the figures are illustrated for simplicity and clarity and have not necessarily been drawn to scale. For example, the dimensions, sizing, and/or relative placement of some of the elements in the figures may be exaggerated relative to other elements to clarify distinctive features of the illustrated embodiments. Also, common but well-understood elements that may be useful or necessary in a commercially feasible embodiment are often not depicted in order to facilitate a less obstructed view of the illustrated embodiments.

### DESCRIPTION OF THE ILLUSTRATED EMBODIMENTS

The following description is not to be taken in a limiting sense, rather for the purpose of describing by specific examples the general principles that are incorporated into the illustrated embodiments. For example, certain actions or steps may be described or depicted in a specific order to be performed. However, practitioners of the art will understand that the specific order is only given by way of example and that the specific order does not exclude performing the described steps in another order to achieve substantially the same result. Also, the terms and expressions used in the description have the ordinary meanings accorded to such terms and expressions in the corresponding respective areas of inquiry and study except where other meanings have been specifically set forth herein.

An important aspect of integrated circuit (IC) design is component isolation, especially in integrated circuits used with high voltages, for example, greater than 100 V. Commonly used methods for component isolation are junction isolation and dielectric isolation. In junction isolation, a reverse bias voltage is applied to a p-n junction to block current flow through the p-n junction. A typical integrated circuit comprises a p-type silicon semiconductor substrate and transistors formed in n-type regions in the substrate. Maintaining electrical isolation between the transistors formed in the n-type regions requires that the voltage applied to the p-type substrate is always lower than the voltage applied to the transistors formed in the n-type regions. In dielectric isolation, an electrically insulating layer of silicon dioxide is formed in the substrate around each transistor to isolate the transistors from the substrate. An example of a technology incorporating dielectric isolation is trenched vertical double-diffused metal oxide semiconductor field effect transistors (DMOS).

As technologies for isolating transistors and other semiconductor switching devices formed in substrates of integrated circuits improve, the maximum voltage rating of transistors and other semiconductor switching devices for integrated circuits likewise improves. As a result, integrated circuits may now include arrays of transistors and other switching devices that are capable of operating at voltages greater than several hundred volts. The capability of controlling high voltage devices with an integrated circuit is advantageously exploited in various embodiments of a device for controlling drive current with amplitude shift modulation as described below. Furthermore, the high voltage integrated circuits may be used in applications for digital controls in power systems.

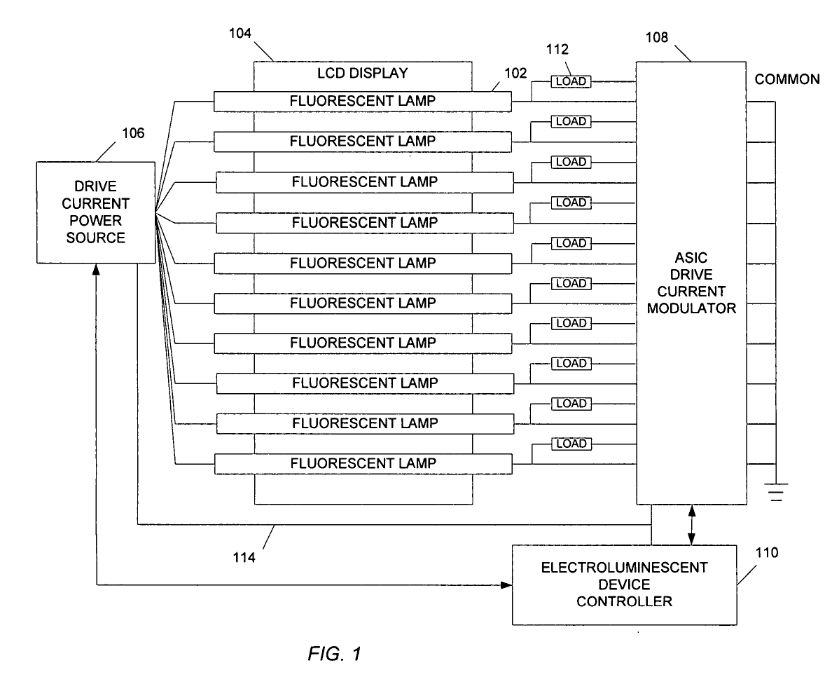

FIG. 1 illustrates a diagram of a backlight for a fluorescent lamp array in which an alternating drive current from a single drive current power source is separately controlled through each lamp by amplitude shift modulation performed by an integrated circuit. Shown in FIG. 1 are an array of fluorescent lamps 102, an LCD display 104, a drive current power source 106, an application specific integrated circuit (ASIC) drive current modulator 108, an electroluminescent device controller (ELD) 110, amplitude shift loads 112, and isolated logic power 114.

In FIG. 1, the array of fluorescent lamps 102 illuminates the back of the LCD display 104. The LCD display 104 produces an image by blocking, passing, or filtering color from the light from the array of fluorescent lamps 102 at each pixel of the LCD display 104. In this example, the array of fluorescent lamps 102 has 10 fluorescent lamps. In other embodiments, the number of lamps, the type of electroluminescent device used for illumination in the array, and the application in which the array is used may differ from the example of FIG. 1 to suit specific applications within the scope of the appended claims. Examples of other electroluminescent devices that may be used with the drive current modulator 108 include light emitting diodes, laser diodes, ionized gas lamps, and incandescent lamps.

The drive current power source 106 may be, for example, an inverter typically used to generate the high voltage typically required to provide drive current to the array of fluorescent lamps 102. For example, the inverter may generate 2,500 VAC to 3000 VAC at a frequency of about 60 KHz with a current capacity to supply approximately 10 mA to each fluorescent lamp in the array of fluorescent lamps 102. The voltage waveform may be, for example, sinusoidal, triangular, or square. Other waveforms may be used to suit specific applications within the scope of the appended claims.

In another embodiment, the drive current power source 106 may supply a DC voltage in applications where other types of electroluminescent devices are used for illumination instead of the fluorescent lamps 102, for example, light emitting diodes and laser diodes. The drive current power source 106 may also include ballast capacitors that are connected in series with each fluorescent lamp 102 to offset the negative resistance characteristic of fluorescent lamps. The ballast capacitors also block any DC component of the power source voltage at the high potential end of the fluorescent lamp 102 so that the average voltage across the fluorescent lamp 102 is zero. Blocking the DC voltage component of the drive current power source 106 minimizes the possibility of arcing that may result in circuit damage or injury to personnel.

The isolated logic power 114 may be, for example, an unregulated DC voltage generated from a separate transformer winding and a rectifier in the drive current power source 106 to supply power for the logic components in the drive current modulator 108 and the electroluminescent device controller (ELD) 110. The isolated logic power 114 is electrically isolated from the high voltage applied to the array of fluorescent lamps 102 to protect the logic components and personnel from high voltage potentials that may result in circuit damage and injury to personnel.

The amplitude shift loads 112 may be, for example, resistors or other suitable voltage dropping devices for passing a minimum drive current from the drive current source 106 through each fluorescent lamp 102 connected in series with the corresponding amplitude shift load 112. The minimum drive current is selected to at least maintain ionization in each fluorescent lamp 102.

In one embodiment, the drive current modulator 108 is economically and compactly packaged on a common substrate in an integrated circuit to control the drive current through each fluorescent lamp 102 independently of the other fluorescent lamps 102 in response to digital switch commands received from the electroluminescent device controller 110. The drive current modulator 108 shunts, or bypasses, the amplitude shift load 112 for a selected bypass interval during each cycle of a modulation frequency. When the amplitude shift load 112 is bypassed, the drive current through the fluorescent lamp 102 decreases from the maximum drive current when the load 112 is connected in series with the fluorescent lamp 102 to the minimum drive current when the load 112 is bypassed. The decrease in current to a minimum when the load 112 is bypassed occurs in devices such as cold cathode fluorescent lamps that exhibit a negative resistance characteristic. In other electroluminescent devices, bypassing the load increases the drive current. The duty cycle of the bypass interval may be selected in digital increments to regulate the average amplitude shift modulated drive current through the corresponding fluorescent lamp 102 precisely and accurately to a stable value. In one embodiment, the drive current through each of the fluorescent lamps 102 is regulated independently from the drive current in the other fluorescent lamps 102.

In contrast to the drive current modulator 108, drive current adjustment circuits found in the prior art typically rely on analog components that may change with temperature, humidity, age, and other environmental factors, resulting in lower stability and accuracy than may be achieved with the digitally controlled amplitude shift modulation performed by the drive current modulator 108. The digitally controlled amplitude shift modulation technique implemented in the drive current modulator 108 also advantageously avoids the need for complex and costly temperature compensation devices that may not be practical to fabricate in an integrated circuit.

The electroluminescent device controller 110 receives status data from the drive current power source 106, for example, the voltage output level, and sends a strike command to the drive current power source 106 to increase the output voltage for striking the fluorescent lamps 102. The electroluminescent device controller 110 also receives digital status data from the drive current modulator 108 that indicates the average amplitude shift modulated drive current through each of the fluorescent lamps 102 and sends a stream of digital switch commands to the drive current modulator 108. In one embodiment, each of the digital switch commands includes one bit of the amplitude shift control signal for each of the fluorescent lamps 102. The digital switch commands are buffered and latched in the drive current modulator 108 at a selected sample rate, for example, 1 MHz, to generate the amplitude shift control signal for each of the fluorescent lamps 102. The digital switch commands may be used to balance the average amplitude shift modulated drive current so that each of the fluorescent lamps 102 has an equal average amplitude shift modulated drive current, or the average amplitude shift modulated drive current may be varied to create special effects by altering the average amplitude shift modulated drive current in some or all of the fluorescent lamps 102 in the array. In other embodiments, variations in components connected to each of the fluorescent lamps 102 in the array may be compensated by varying the average drive current in each of the fluorescent lamps 102.

In one embodiment, the electroluminescent device controller 110 is economically and compactly packaged in a separate integrated circuit from the drive current modulator 108. Alternatively, the electroluminescent device controller 110 may be included in the same integrated circuit with the drive current modulator 108. The electroluminescent device controller 110 determines the duty cycle of the digital switch commands, for example, by maintaining a database of various electroluminescent devices and systems so that the same electroluminescent device controller 110 may be used with a number of different electroluminescent devices such as backlights for LCD displays in television sets from different manufacturers. The electroluminescent device database provides a knowledge base that may be used, for example, for setting the nominal drive current for each type of electroluminescent device and for adjusting the drive current to compensate for aging of the electroluminescent device.

In one embodiment, an electrical circuit includes:

a switch having an on state and an off state for connecting a single drive current power source in series with an electroluminescent device for each electroluminescent device of an electroluminescent device array to conduct a first drive current through the electroluminescent device in the on state and for connecting an amplitude shift load in series with the electroluminescent device and the drive current power source to conduct a second drive current through the electroluminescent device in the off state so that the first drive current and the second drive current constitute an amplitude shift modulated drive current through the electroluminescent device; and

a control signal generator for receiving a digital switch command for each electroluminescent device from an electroluminescent device controller and for generating an amplitude shift control signal to cause the switch to switch between the on state and the off state for regulating an average of the amplitude shift modulated drive current.

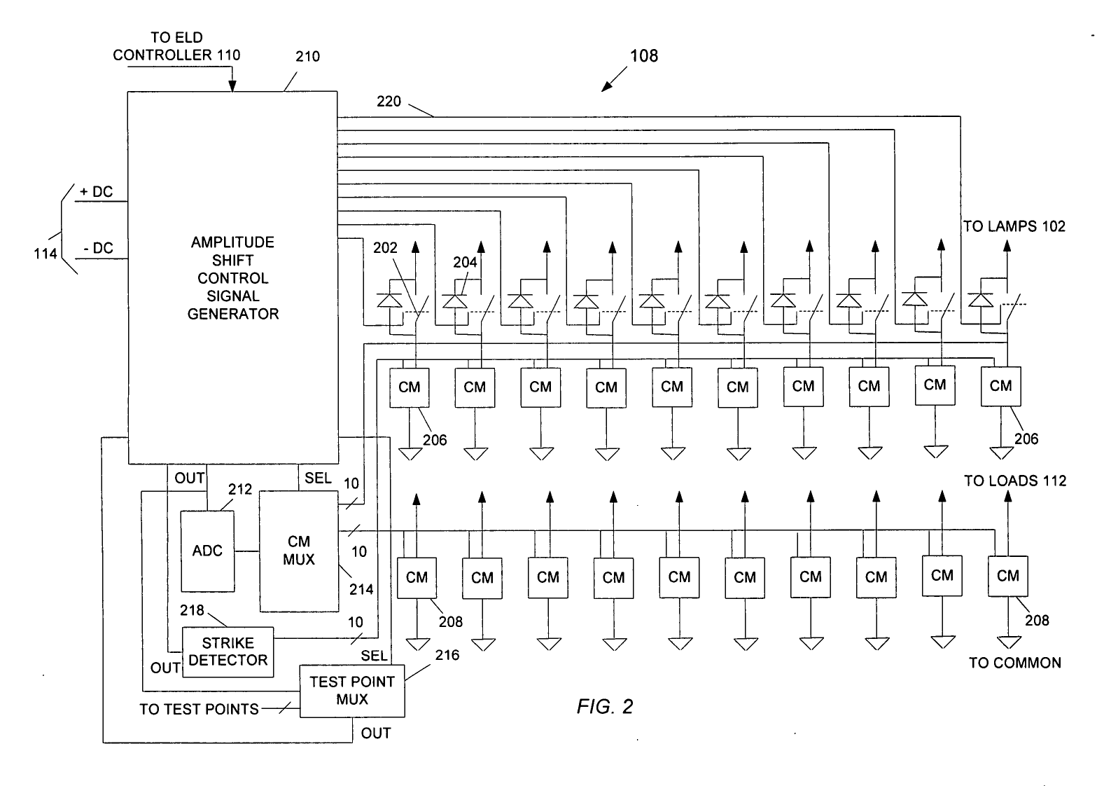

FIG. 2 illustrates a schematic diagram of an embodiment of the drive current modulator 108 in FIG. 1. Shown in FIG. 2 are isolated logic power 114, switches 202, bypass diodes 204, current mirrors (CM) 206 and 208, an amplitude shift control signal generator 210, an analog-to-digital converter (ADC) 212, a current mirror multiplexer (CM MUX) 214, a test point multiplexer (TEST POINT MUX) 216, a strike detector 218 and amplitude shift control signals 220.

In FIG. 2, the switches 202 may be, for example, single trench or double trench double-diffused metal oxide semiconductor transistors (DMOS). Each of the switches 202 is switched independently of the other switches 202 by one of the amplitude shift control signals 220 between an ON state and an OFF state. In the ON state, the voltage across the switch is, low, for example, less than 1 V. In the OFF state, the current through the switch is low, for example, less than 1 μA. The resulting low product of the voltage and the current advantageously minimizes power dissipation and heat generation in the integrated circuit package and conserves power. The switches 202 are connected to the fluorescent lamps 102 in FIG. 1 via pins on the integrated circuit package.

The bypass diodes 204 may be, for example, Schottky diodes. The bypass diodes 204 bypass the components in the drive current modulator 108 to common when the polarity of the voltage applied to the fluorescent lamps 102 reverses, protecting the drive current modulator 108 from voltage breakdown. The bypass diodes 204 are connected to common and to the fluorescent lamps 102 via pins on the integrated circuit package. Because the switches 202 are bypassed when the polarity of the drive current is opposite the polarity of the switches 202 the drive current modulator 108 only regulates one polarity of an alternating drive current. To regulate both polarities of an alternating drive current, a second drive current modulator 108 and a second set of loads 112 may be connected at the other end of the array of fluorescent lamps 102 so that one drive current modulator 108 regulates one polarity of the alternating drive current and the other drive current modulator 108 regulates the other polarity of the alternating drive current.

The current mirrors (CM) 206 may be formed according to well-known techniques to provide an accurate duplicate of the drive current through each of the fluorescent lamps 102 in the drive current modulator 108. The duplicate current from the current mirrors (CM) 206 is used to measure the average drive current through each corresponding fluorescent lamp 102. Likewise, the current mirrors (CM) 208 provide an accurate duplicate of the drive current through each of the loads 112 in the drive current modulator 108. The duplicate current from the current mirrors (CM) 208 is used to measure the average drive current through each corresponding load 112. The current mirrors (CM) 208 are connected to common and to the loads 112 via pins on the integrated circuit package.

The amplitude shift control signal generator 210 may be implemented according to well-known digital logic circuit techniques, for example, as a shift register and a latch, or a parallel bus, to assemble the digital switch commands from the electroluminescent device controller 110 into a digital word. The digital word is latched to the amplitude shift control signals 220 at a selected sample rate, for example, 1 MHz. In the example of FIG. 2, the amplitude shift control signal generator 210 includes bits for selecting a multiplexed signal in the drive current modulator 108.

The analog-to-digital converter (ADC) 212 may be implemented, for example, as a dual-slope analog-to-digital converter. The analog-to-digital converter (ADC) 212 charges a capacitor from a reference voltage by a reference current to a threshold voltage and then discharges the capacitor through one of the current mirrors (CM) 206 or 208 selected by the current mirror multiplexer (CM MUX) 214 back to the reference voltage. The number of clock cycles required to charge and discharge the capacitor is counted by the electroluminescent device controller 110. The current through the current mirror 206 or 208 selected by the current mirror multiplexer (CM MUX) 214 is calculated by the electroluminescent device controller 110 as a linear function of the number of clock cycles required to charge the capacitor divided by the number of clock cycles required to discharge the capacitor times the value of the reference current. The average amplitude modulated drive current through each of the fluorescent lamps 102 and the average amplitude modulated load current through each of the loads 112 may be represented as a digital value, for example, with an accuracy of 0.5 percent in a range between 3 mA and 10 mA.

The current mirror multiplexer (CM MUX) 214 connects one of the current mirrors (CM) 206 or 208 to the analog-to-digital converter (ADC) 212 in response to a select signal from the electroluminescent device controller 110 via the amplitude shift control signal generator 210.

The test point multiplexer (TEST POINT MUX) 216 connects one of a selected number of test points, for example, the output of the analog-to-digital converter (ADC) 212, to the electroluminescent device controller 110 in response to a select signal from the amplitude shift control signal generator 210. This feature provides a tool for passing test point data from inside the drive current modulator 108 to the electroluminescent device controller 110. A host computer (not shown) may be connected to the electroluminescent device controller 110, for example, to display the test point data to a user via a graphical user interface (GUI). A host computer, such as an LCD controller (not shown) may also be connected to the electroluminescent display controller (110) to direct the operation of the electroluminescent device array in response to an analysis of video to be displayed for the purpose of saving power or enhancing the quality of the image.

The strike detector 218 may be, for example, a current mirror connected to each of the switches 202 and a comparator connected to each of the current mirrors. The comparator generates a logical one when the average amplitude modulated drive current measured by the current mirror exceeds the ionization current of the fluorescent lamps 102. The outputs of the comparators are ANDed together to generate the struck signal when the average amplitude modulated drive current through each of the fluorescent lamps 102 exceeds the ionization current. In another embodiment, the electroluminescent device controller 110 can determine from the average, instantaneous, or root-mean-square amplitude modulated drive currents when each of the fluorescent lamps 102 is struck.

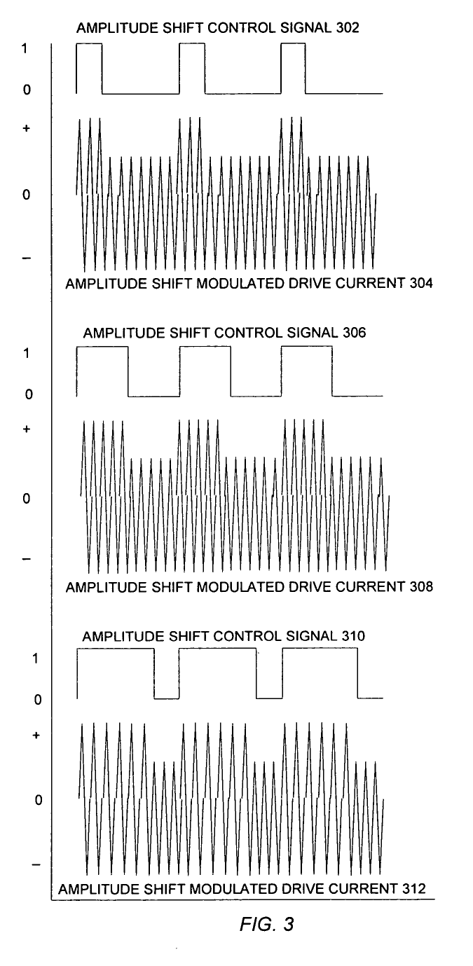

FIG. 3 illustrates a timing diagram of amplitude shift control signals having three different duty cycles and the instantaneous amplitude shift modulated drive current through the switches 202 in FIG. 2. Shown in FIG. 3 are amplitude shift control signals 302, 306, and 310; and instantaneous amplitude shift modulated drive currents 304, 308, and 312.

In the embodiment of FIG. 3, a triangular waveform is used to illustrate the instantaneous amplitude shift modulated drive currents 304, 308, and 312. In practice, the period of the amplitude shift control signals 302, 306, and 310 may be, for example, about 1 msec having a corresponding frequency of 1 kHz, and the frequency of the alternating drive current from the drive current power source 106 in FIG. 1 may be about 60 kHz. By clocking the amplitude shift control signal samples at a sample rate of about 1 MHz, the average amplitude shift modulated drive current may be adjusted in increments of about (1 kHz/1 MHz)=0.1 percent of the range between the minimum and maximum drive current. For example, if the minimum amplitude modulated drive current is 3 mA and the maximum amplitude modulated drive current is 10 mA, then the average amplitude modulated drive current may be adjusted in the range between 3 and 10 mA in increments of about 0.1 percent times (10−3) mA=7 μA.

In FIG. 3, the amplitude shift control signal 302 and the resulting amplitude shift modulated drive current 304 have a duty cycle of about 25 percent. The amplitude shift control signal 306 and the resulting amplitude shift modulated drive current 308 have a duty cycle of about 50 percent. The amplitude shift control signal 310 and the resulting amplitude shift modulated drive current 312 have a duty cycle of about 75 percent.

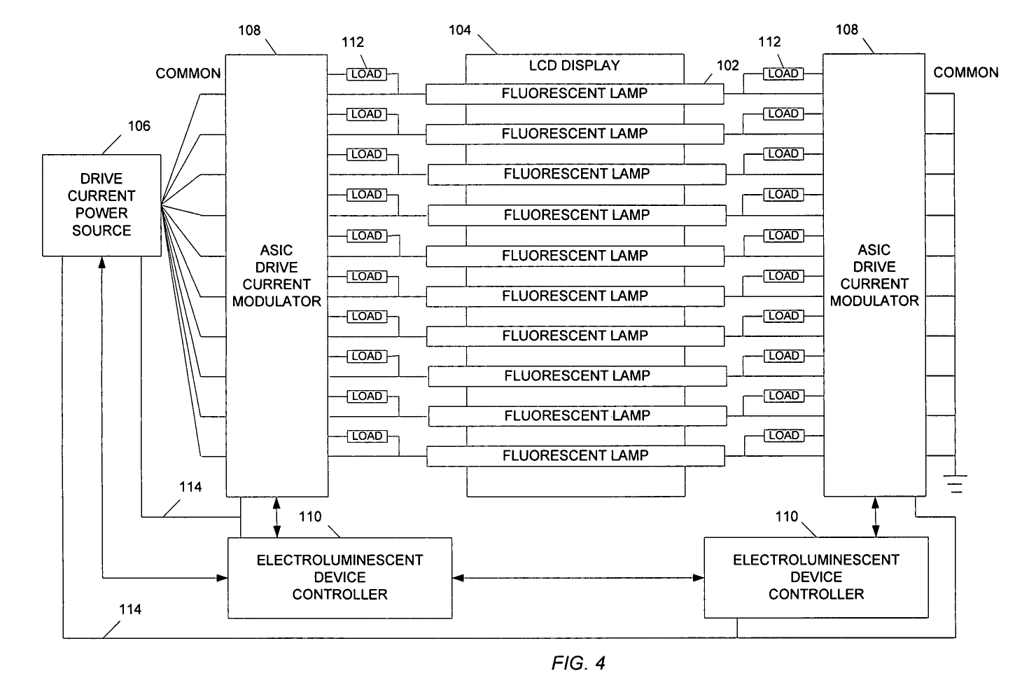

FIG. 4 illustrates a diagram of a backlight for a fluorescent lamp array in which an alternating drive current from a single drive current power source is separately controlled through each fluorescent lamp by amplitude shift modulation performed by two of the integrated circuits of FIG. 2. Shown in FIG. 4 are an array of fluorescent lamps 102, an LCD display 104, a drive current power source 106, application specific integrated circuit (ASIC) drive current modulators 108, electroluminescent device controllers 110, and amplitude shift loads 112.

The configuration of FIG. 4 is the same as that described above for FIG. 1, except that a second drive current modulator 108 and a second electroluminescent device controller 110 are inserted between the drive current power source 106 and the array of fluorescent lamps 102. In this arrangement, the common polarity (COMMON) of the second drive current modulator 108 is connected to the drive current power source 106 so that the second drive current modulator 108 regulates the positive polarity of the alternating drive current. The combination of both drive current modulators 108 provides regulation for both polarities of the alternating drive current from the drive current power source 106.

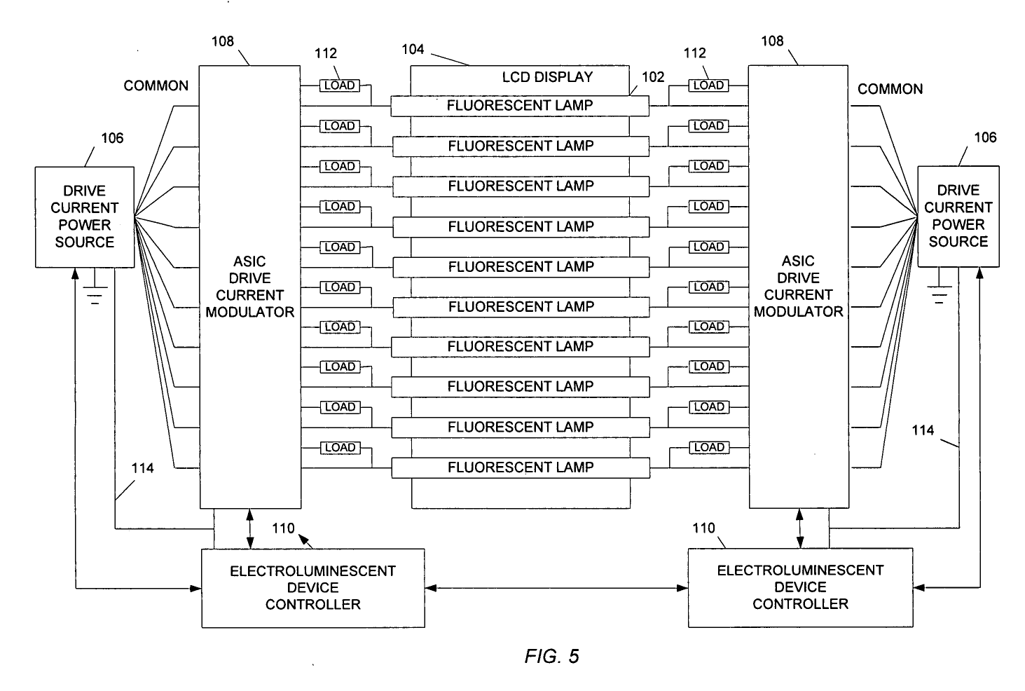

FIG. 5 illustrates a diagram of a backlight for a fluorescent lamp array in which an alternating drive current from two differentially configured drive current power sources is separately controlled through each lamp by amplitude shift modulation performed by two of the integrated circuits of FIG. 2. Shown in FIG. 5 are an array of fluorescent lamps 102, an LCD display 104, drive current power sources 106, application specific integrated circuit (ASIC) drive current modulators 108, electroluminescent device controllers 110, and amplitude shift loads 112.

The configuration of FIG. 5 is the same as that described above for FIG. 4, except that a second drive current power source 106 is inserted between the first drive current modulator 108 and ground. The drive current power sources 106 may be, for example, master/slave inverters operating in push-pull so that one voltage output is negative when the other is positive and vice versa. In this embodiment, the maximum voltage above ground is only half that of the configuration in FIG. 4, reducing the possibility of arcing to ground.

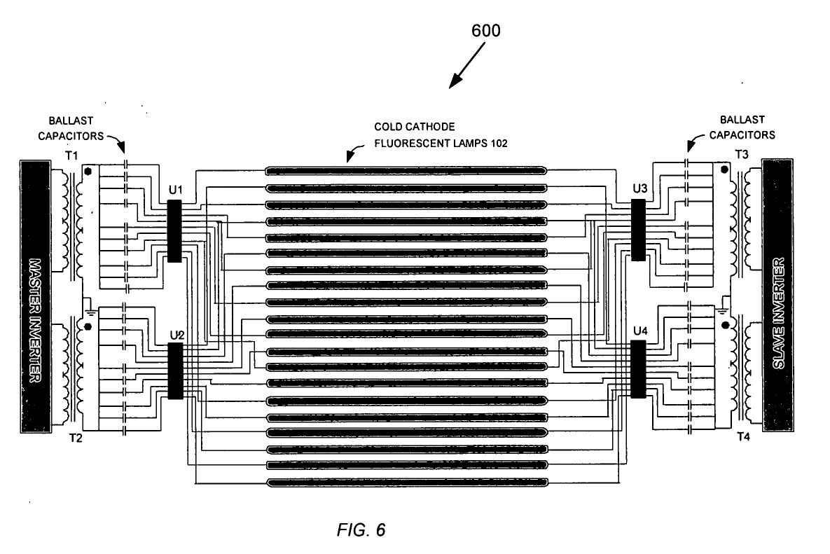

FIG. 6 illustrates a diagram of a backlight for a fluorescent lamp array in which an alternating drive current from four differentially configured drive current power sources is separately controlled through each fluorescent lamp by amplitude shift modulation performed by four of the ASIC drive current modulators 108 of FIG. 2. Shown in FIG. 6 are drive current power source transformers T1, T2, T3, and T4; drive current modulators U1, U2, U3, and U4; and fluorescent lamps 102.

The configuration of FIG. 6 is a doubling of that described above for FIG. 5. In the arrangement of FIG. 6, the differential configuration of the drive current power source transformers T1, T2, T3, and T4 drives each of the fluorescent lamps 102 with a drive current that is opposite in polarity to each adjacent fluorescent lamp 102. The alternating polarity of adjacent fluorescent lamps may be used to compensate for an imbalance in the light output between opposite ends of the fluorescent lamps 102. The DC components of the drive current power sources T1, T2, T3, and T4 are removed by the ballast capacitors, reducing the maximum voltage between the drive current power sources T1, T2, T3, and T4 and ground to half the peak-to-peak voltage from drive current power source transformers T1, T2, T3, and T4. The reduction in the maximum voltage advantageously reduces the corresponding hazard of accidental injury from electrical shock.

In other embodiments, the drive current modulator 108 of FIG. 2 may be configured to include the switches and the amplitude shift control signal generator and one or more of the other functions illustrated in FIG. 2 in various combinations to suit specific applications within the scope of the appended claims.

In another embodiment, an integrated circuit includes:

a common substrate;

a switch having an on state and an off state formed on the common substrate for connecting a single drive current power source in series with an electroluminescent device for each electroluminescent device of an electroluminescent device array to conduct a first drive current through the electroluminescent device in the on state and for connecting an amplitude shift load in series with the electroluminescent device and the drive current power source to conduct a second drive current through the electroluminescent device in the off state so that the first drive current and the second drive current constitute an amplitude shift modulated drive current through the electroluminescent device; and

a control signal generator formed on the common substrate for receiving a digital switch command for each electroluminescent device from an electroluminescent device controller and for generating an amplitude shift control signal to cause the switch to switch between the on state and the off state for regulating an average of the amplitude shift modulated drive current; and at least one of:
a bypass diode formed on the common substrate and coupled to the switch;
a strike detector formed on the common substrate for generating a struck signal when the average drive current exceeds a minimum drive current threshold in every electroluminescent device in the electroluminescent device array and for holding the switch in the on state until the struck signal is generated,
a strike detector formed on the common substrate for generating a struck signal when the drive current source has been powered on for a selected time interval and for holding the switch in the on state until the struck signal is generated,
a drive current sensor formed on the common substrate for measuring one of the average, instantaneous, or root-mean-square amplitude shift modulated drive current and an average, instantaneous, or root-mean-square amplitude shift modulated load current and for generating a digital output to the electroluminescent device controller having a value that is representative of a linear function of one of the average amplitude shift modulated drive current and the average amplitude shift modulated load current; and
a shift register formed on the common substrate for one of assembling the amplitude shift control signal for every electroluminescent device in the electroluminescent device array into a digital word, for assembling a test signal into the digital word that includes a bit for selecting one of a current mirror to measure one of the average amplitude shift modulated drive current and an average amplitude shift modulated load current, and for selecting a test point in the electrical circuit to couple to the electroluminescent device controller.

The specific embodiments and applications thereof described above are for illustrative purposes only and do not preclude modifications and variations that may be made within the scope of the following claims.

What is claimed is:

1. An electrical circuit comprising:
a switch having an on state and an off state for connecting a single drive current power source in series with an electroluminescent device for each electroluminescent device of an electroluminescent device array to conduct a first drive current through the electroluminescent device in the on state and for connecting an amplitude shift load in series with the electroluminescent device and the drive current power source to conduct a second drive current through the electroluminescent device in the off state so that the first drive current and the second drive current constitute an amplitude shift modulated drive current through the electroluminescent device; and
a control signal generator for receiving a digital switch command for each electroluminescent device from an electroluminescent device controller and for generating an amplitude shift control signal to cause the switch to switch between the on state and the off state for regulating an average of the amplitude shift modulated drive current.

2. The electrical circuit of claim 1 further comprising a strike detector for generating a struck signal when the drive current exceeds a minimum drive current threshold in every electroluminescent device in the electroluminescent device array and for holding the switch in the on state until the struck signal is generated.

3. The electrical circuit of claim 1 further comprising a strike detector for generating a struck signal when the drive current power source has been powered on for a selected time interval and for holding the switch in the on state until the struck signal is generated.

4. The electrical circuit of claim 1 further comprising a drive current sensor for measuring one of the average amplitude shift drive current and an average amplitude shift load current and for generating a digital output to the electroluminescent device controller having a value that is representative of a linear function of one of the average amplitude shift drive current and the average amplitude shift load current.

5. The electrical circuit of claim 4 further comprising the drive current sensor implemented as a dual-slope analog-to-digital converter and a current mirror.

6. The electrical circuit of claim 1 further comprising the electroluminescent device array.

7. The electrical circuit of claim 6 further comprising the electroluminescent device array implemented as fluorescent lamps, light emitting diodes, laser diodes, incandescent lamps, or a combination thereof.

8. The electrical circuit of claim 1 further comprising the amplitude shift control signal generator implemented as a shift register for assembling the separate amplitude shift control signal for every electroluminescent device in the electroluminescent device array into a digital word.

9. The electrical circuit of claim 8 further comprising a bit in the digital word for selecting a current mirror to measure one of the average, instantaneous, or root-mean-square amplitude shift modulation drive current and an average, instantaneous, or root-mean-square amplitude shift modulation load current.

10. The electrical circuit of claim 8 further comprising a bit in the digital word for selecting a test point in the electrical circuit to couple to the electroluminescent device controller.

11. An integrated circuit comprising:
a common substrate;
a switch having an on state and an off state formed on the common substrate for connecting a single drive current power source in series with an electroluminescent device for each electroluminescent device of an electroluminescent device array to conduct a first drive current through the electroluminescent device in the on state and for connecting an amplitude shift load in series with the electroluminescent device and the drive current power source to conduct a second drive current through the electroluminescent device in the off state so that the first drive current and the second drive current constitute an amplitude shift modulated drive current through the electroluminescent device; and
a control signal generator formed on the common substrate for receiving a digital switch command for each electroluminescent device from an electroluminescent device controller and for generating an amplitude shift control signal to cause the switch to switch between the on state and the off state for regulating an average of the amplitude shift modulated drive current; and at least one of:
a bypass diode formed on the common substrate and coupled to the switch;
a strike detector formed on the common substrate for generating a struck signal when the average drive current exceeds a minimum drive current threshold in every electroluminescent device in the electroluminescent device array and for holding the switch in the on state until the struck signal is generated,
a strike detector formed on the common substrate for generating a struck signal when the drive current source has been powered on for a selected time interval and for holding the switch in the on state until the struck signal is generated,
a drive current sensor formed on the common substrate for measuring one of the average, instantaneous, or root-mean-square amplitude shift modulated drive current and an average, instantaneous, or root-mean-square amplitude shift modulated load current and for generating a digital output to the electroluminescent device controller having a value that is representative of a linear function of one of the average amplitude shift modulated drive current and the average amplitude shift modulated load current; and
a shift register formed on the common substrate for one of assembling the amplitude shift control signal for every electroluminescent device in the electroluminescent device array into a digital word, for assembling a test signal into the digital word that includes a bit for selecting one of a current mirror to measure one of the average amplitude shift modulated drive current and an average amplitude shift modulated load current, and for selecting a test point in the electrical circuit to couple to the electroluminescent device controller.

12. The electrical circuit of claim 1 further comprising the drive current power source.

13. The electrical circuit of claim 12 further comprising the drive current power source implemented as an alternating current source.

14. The electrical circuit of claim 13 further comprising the drive current power source configured to operate at a frequency of about 60 KHz.

15. The electrical circuit of claim 1 further comprising the amplitude shift control signal having a period of about one millisecond.

16. The electrical circuit of claim 1 further comprising the amplitude shift control signal having a selectable duty cycle of at least three different digitally selected values in the range between zero and 100 percent.

17. The electrical circuit of claim 1 further comprising a bypass diode coupled to the switch.
